(19) United States
(12) Patent Application Publication
(10) Pub. No.: US 2007/0202950 A1
(43) Pub. Date: Aug. 30, 2007

(54) Wireless game controller with integrated audio system

(76) Inventors: Saied Hussaini, Miami, FL (US); Marc Iacovelli, Miami, FL (US)

Correspondence Address: BERENATO, WHITE & STAVISH, LLC, 6550 ROCK SPRING DRIVE, SUITE 240, BETHESDA, MD, 20817, US

(21) Appl. No.: 11/650,584

(22) Filed: Jan. 8, 2007

Related U.S. Application Data
(63) Continuation-in-part of application No. 11/071,591, filed on Mar. 4, 2005.
(60) Provisional application No. 60/756,564, filed on Jan. 6, 2006.

(51) Int. Cl. A63F 9/24; G06F 19/00

(52) U.S. Cl. 463/39

(57) ABSTRACT

A wireless computer game controller with integrated audio system that sends and receives audio signal via integrated circuitry provided in the controller. The wireless interface (transmitter/receiver) establishes a communication link to facilitate the transmission of both command signals and audio/video signals between the controller and computer device to thereby provide two-way interaction with the stand-alone computer device within a single accessory device. The controller circuitry also incorporates a speaker or headphone jack to deliver audio stimulation. In the preferred embodiment, the controller sends an audio signal to an ear piece where the ear piece includes a separate microphone to transmit audio to a separate receiver or a third party.

The present invention claims the benefit of U.S. provisional application Ser. No. 60/756,564 filed on Jan. 6, 2006 and is a Continuation-In Part application of pending U.S. application Ser. No. 11/071,591 filed Mar. 4, 2005, each of which are hereby incorporated herein by reference.

### BACKGROUND OF THE INVENTION

1. Field of the Invention

The present invention relates to video game controllers and more specifically to a wireless controller with integrated audio system for providing an interactive video game.

2. Description of the Related Art

Computer video games are well known in the art. Such devices range from small hand held all-in-one units, to larger stand-alone units which interact with stand alone controllers and stand alone video display devices. Small hand held devices are very portable. However, the graphics and sophistication game play are substantially inferior to stand alone units due limited processing power and associated peripherals. For more sophisticated play, stand alone computer units provide tremendous processing power and work with associated peripheral devices, such as a remote controller and television display in an attempt to bring the player a more dramatic gaming experience to that of hand held devices.

FIG. 1 depicts such a conventional stand-alone computer video gaming device. A central stand-alone console contains all the essential processing components to run a computer game. A controller is connected to communicate operation control commands from a user. A separate display is connected to the gaming deice to display interactive video gaming images. As previously mentioned, this conventional arrangement is well known in the art.

With the tremendous commercial success of stand alone computer gaming systems, and entire peripheral market has emerged ranging from advanced video controllers, joysticks, steering wheel devices for racing games, multi-tap controllers, vibrating controllers, video stands, audio systems and the like. Programmable controllers are also available which allow a user to customize the operation of control buttons and to even store and retrieved such customized arrangements.

Furthermore, wireless controllers are becoming increasingly more popular. However, these wireless controllers are limited in their audio capabilities.

Current wired controllers include a memory card port capable of receiving a memory card shaped audio unit that plugs into the memory port, whereby a head/microphone system connects into the memory card shaped unit via an audio plug. These prior art retro-fit systems are not integrated into the controller circuitry and require additional components in the form of the memory card shaped unit with an audio jack.

### SUMMARY OF THE INVENTION

The present invention is directed to a wireless computer game controller with integrated audio system that sends and receives audio signal via integrated circuitry provided in the controller. The wireless interface (transmitter/receiver) establishes a communication link to facilitate the transmission of both command signals and audio/video signals between the controller and computer device to thereby provide two-way interaction with the stand-alone computer device within a single accessory device. The controller circuitry also incorporates a speaker or headphone jack to deliver audio stimulation. In the preferred embodiment, the controller sends an audio signal to an ear piece where the ear piece includes a separate microphone to transmit audio to a separate receiver or a third party.

The video game controller, which interacts with a stand-alone computer gaming system, comprises a hand held body having a plurality of operation members logistically positioned for manipulation by a user; transmitter/receiver circuitry integrated into the hand held body for sending and receiving wireless control signals to and from a game controller; and audio circuitry capable of sending an audio signal to at least one speaker.

The controller includes an audio port adapted to communicate with a headset that connects with said controller via the audio port, and the audio signal may be the primary audio signal coming from the television and/or game console or the audio signal may be secondary audio, for example, a different audio signal sent directly from another player's headset/microphone. In this case, players may communicate directly with each other via the headset assembly.

This invention provides an integrated wireless controller circuitry where audio is sent by the controller to an ear piece, where the audio signal not necessarily the same audio that is coming from the television. An audio signal is also transmitted from a microphone electrically connected to the controller that permits that player to communicate and talk to other players independently of the game console.

With the preferred embodiment of this invention, the wireless controller includes an audio jack to provide an electrical connection to a headset; a mute button; and a volume control switch.

These and other benefits of the present invention will be apparent to those of skill in the art from the attached drawings and associated description.

### BRIEF DESCRIPTION OF THE DRAWINGS

FIG. 1 is an illustration showing an overview of an interactive computer graphics system.

FIG. 2 is a plan view of a controller according to one embodiment of the present invention.

FIG. 3 is a perspective view of the controller of FIG. 2.

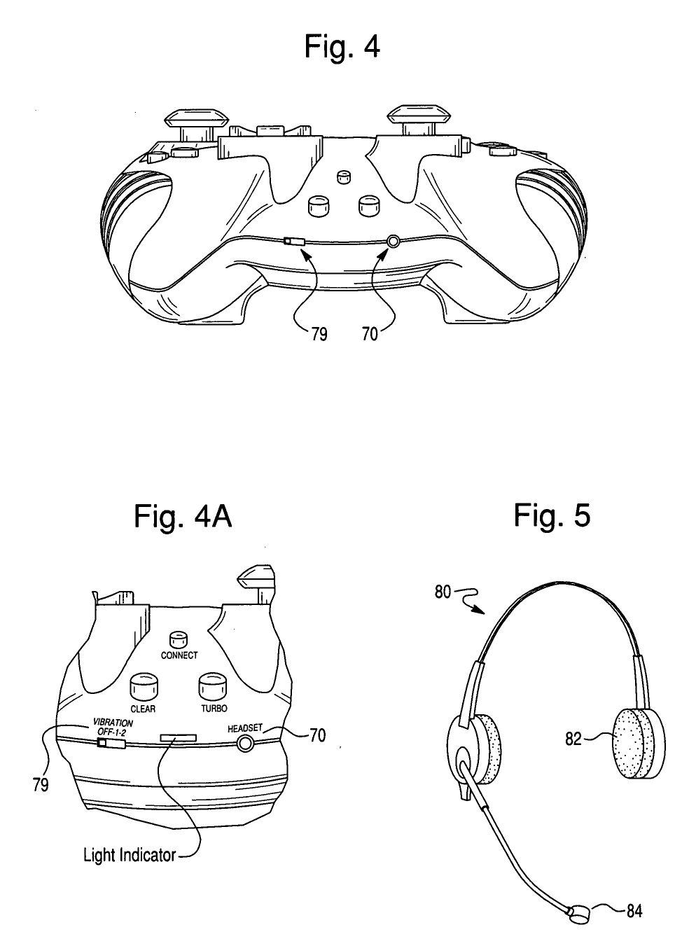

FIG. 4 is a rear view of the controller of FIG. 2 taken in the view III-III.

Fig. A is an exploded isolated view of FIG. 4.

FIG. 5 is a schematic showing an exemplary headset and microphone system.

FIG. 6 is an illustration of an alternate embodiment of the present invention.

FIGS. 7-8 represent block and schematic diagrams of the circuitry and control

FIGS. 9A-9B illustrates an alternate embodiment of the present invention.

### DETAILED DESCRIPTION OF THE PREFERRED EMBODIMENTS

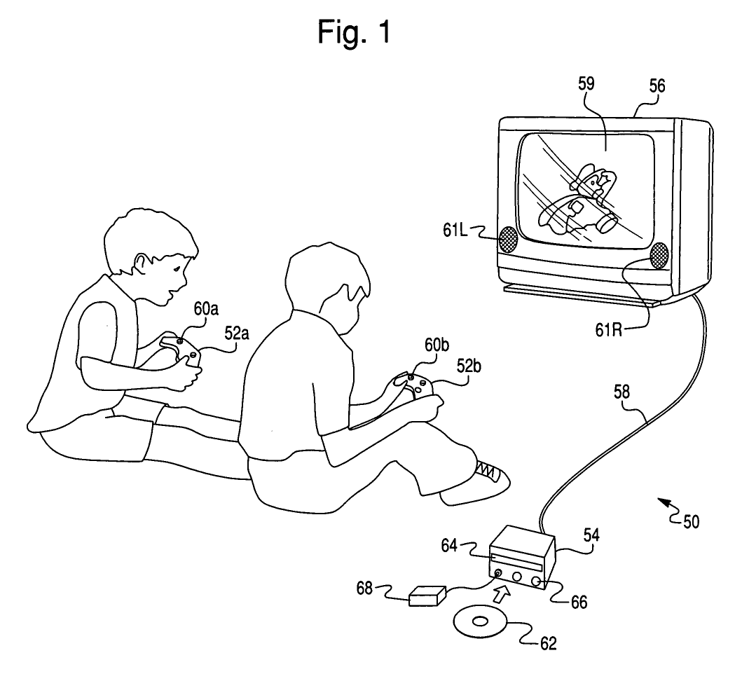

FIG. 1 shows an example of an interactive computer graphics system 50. System 50 can be used to play interactive video games with interesting stereo sound. It can also be used for a variety of other applications.

In this example, system 50 is capable of processing, interactively in real time, a signal in response to real time inputs from wireless handheld controllers 52a, 52b or other input devices received by a wireless adaptor 68. The wireless adaptor 68 provides the capability of sending and receiving wireless control signals between the game console 54 and the controllers 52a, 52b

To play a video game or other application using system 50, the user first connects a main unit or game console 54 to a television set or other video display device 56 or other display device by connecting a cable 58 between the two. Game console 54 produces both video signals and audio signals for controlling the video display device 56. The video signals are what controls the images displayed on the television screen 59, and the audio signals are played back as sound through television stereo loudspeakers 61L, 61R.

The user also needs to connect game console 54 to a power source. This power source may be a conventional AC adapter (not shown) that plugs into a standard home electrical wall socket and converts the house current into a lower DC voltage signal suitable for powering the game console 54. Batteries could be used in other implementations.

The users typically use hand controllers 52a, 52b to control main unit 54. Controls (e.g., button, levers, joysticks, etc.) 60a, 60b can be used, for example, to specify the direction (up or down, left or right, closer or further away) that a character displayed on television 56 should move. Controls 60a, 60b also provide input for other applications (e.g., menu selection, pointer/cursor control, etc.). Controllers 52a, 52b can take a variety of forms. In this example, controllers 52a, 52b shown each include controls 60a, 60b such as joysticks, push buttons and/or directional switches. Typically, such controllers 52a, 52b may be connected to game console 54 by cables or wirelessly via electromagnetic (e.g., radio or infrared) waves.

To play an application such as a game, the user selects an appropriate storage medium 62 (e.g., CD, DVD, etc.) storing the video game or other application he or she wants to play, and inserts that storage medium into a slot 64 in game console 54. Storage medium 62 may, for example, be a specially encoded and/or encrypted optical and/or magnetic disk that stores commands for graphics and audio processor 114 and/or instructions controlling main processor 110 to develop such commands. The user may operate a power switch 66 to turn on game console 54 and cause the main unit to begin running the video game or other application based on the software stored in the storage medium 62. The user may operate controllers 52 to provide inputs to game console 54. For example, operating a control 60a, 60b may cause the game or other application to start. Moving other controls 60a, 60b can cause animated characters to move in different directions or change the user's point of view. Depending upon the particular software stored within the storage medium 62, the various controls 60a, 60b on the controller 52a, and 52b can perform different functions at different times.

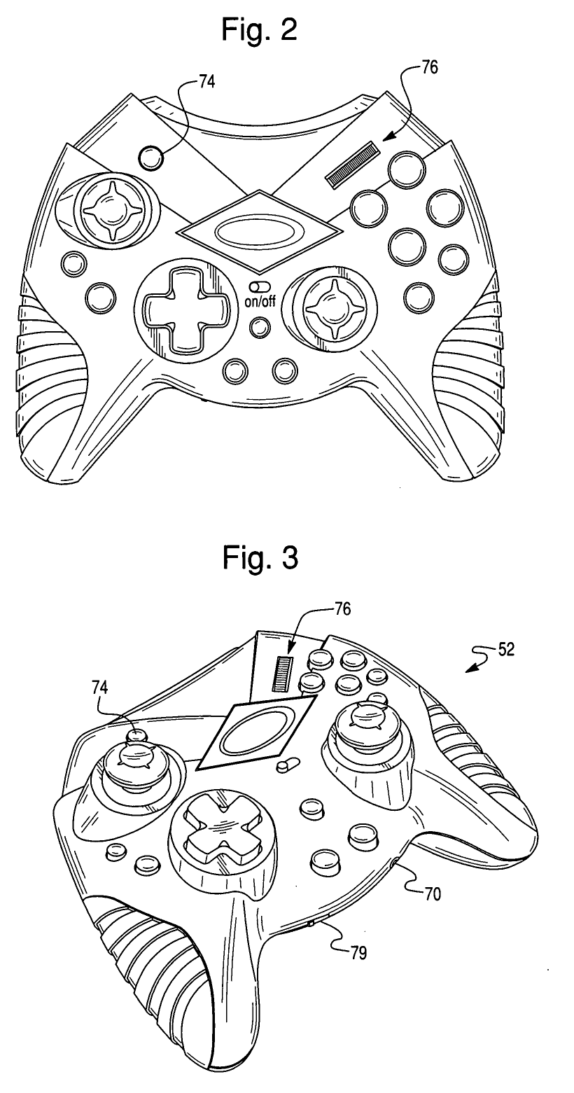

FIG. 2 depicts a video game controller 52 according to one embodiment of the present invention. The hand held controller 52 ergonomically formed and communicates using wireless signals with the adaptor 68 connected to the game console 54. The hand held controller 52 includes a plurality of operating members for manipulation of the users hand to facilitate interaction with game play. These operating members are generally known to those of skill in the art; however, this invention requires additional unique control and operating members including an audio jack 70 into which a headset 80 is plugged; a mute button 74 to mute the volume/audio signal; and a volume control 76, for example, in the form of a dial or switch to selectively set the volume of the audio signal.

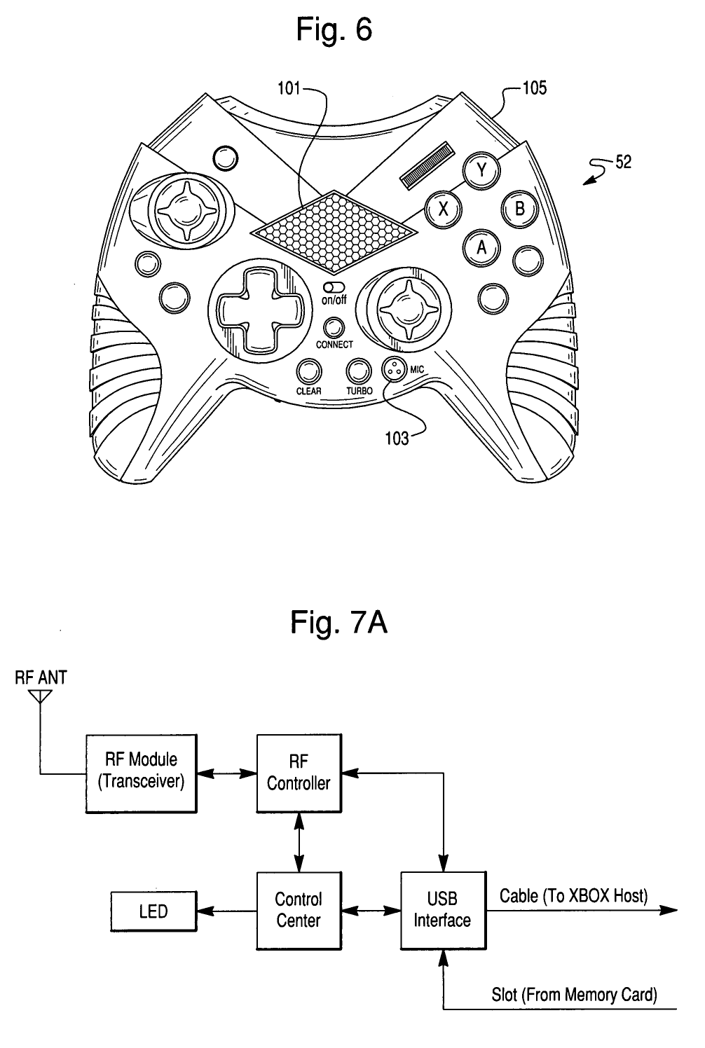

As known in the art, the controller may be the programmable type, include a vibratory (e.g., rumble) member for heightened game play as well as lighted buttons etc. In this case, a vibration switch 79 is provided to control the vibration/rumble function with 3 position settings; vibration off, vibration low intensity, & vibration high intensity. (See FIG. 4a.)

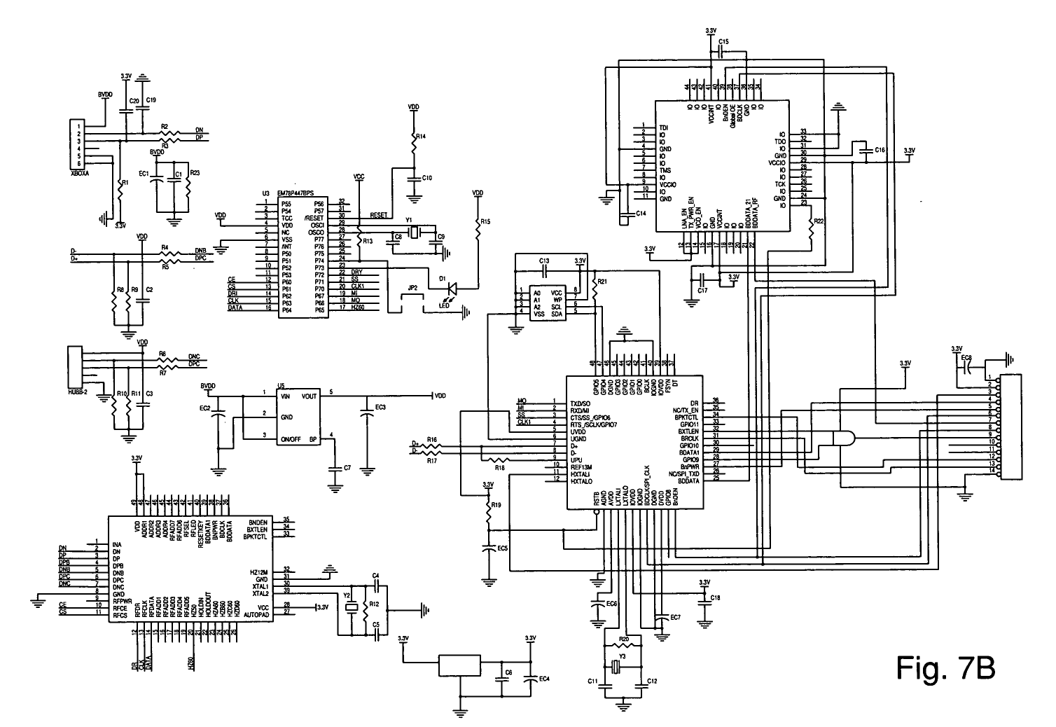

The video game controller 52, which interacts with a stand-alone computer gaming system, comprises a hand held body having a plurality of operation members logistically positioned for manipulation by a user; transmitter/receiver circuitry integrated into the hand held controller 52 for sending and receiving wireless control signals to and from a game console 54 via a wireless adaptor 68; and audio circuitry capable of sending an audio signal to at least one speaker; e.g., a headset 80 as shown in FIG. 5.

The controller 52 includes an audio port 70 adapted to communicate with a headset 80 that connects with the controller 52 via the audio port 70, and the audio signal may be the primary audio signal coming from the television 56 and/or game console 54 or the audio signal may be secondary audio, for example, a different audio signal sent directly from another player's headset/microphone 80. In this case, players may communicate directly with each other via the headset assembly 80 to enhance the game experience and player camaraderie.

This invention provides an integrated wireless controller circuitry where audio is sent by the controller to an ear piece 82, where the audio signal not necessarily the same audio that is coming from the television. An audio signal is also transmitted from a microphone 84 electrically connected to the controller 52 that permits that player to communicate and talk to other players independently of the game console 54.

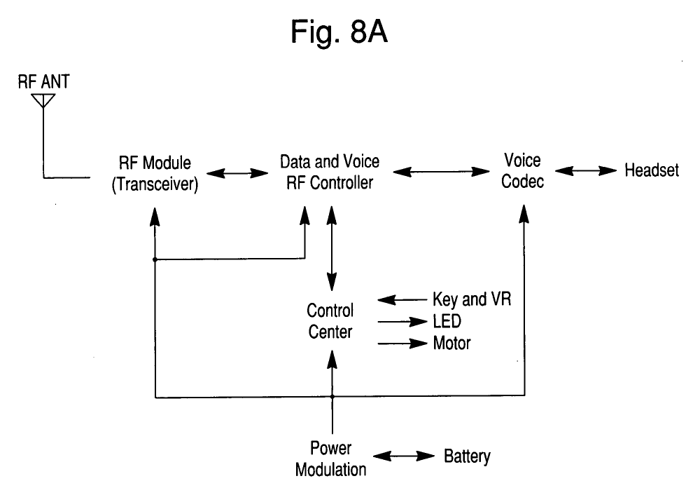

FIG. 6 represents an alternate embodiment of the present invention. In this embodiment the controller 52 incorporates an integrated speaker 101 and microphone 103. Inserting the speaker and microphone into the wireless controller eliminates the necessity for wearing a head set with microphone boom as well as the wired connection to the controller 52 this enhancing the wireless play of the X-box live playing session. A volume control dial 105 is also included to adjust the volume level of audio from the controller. The speaker preferably is made of a piezo eclectic material to ergonomically integrate with the top surface of the controller. It is to be understood that one of ordinary skill in the art may make use of conventional speakers and microphones and establish communication with the internal circuitry of the controller.

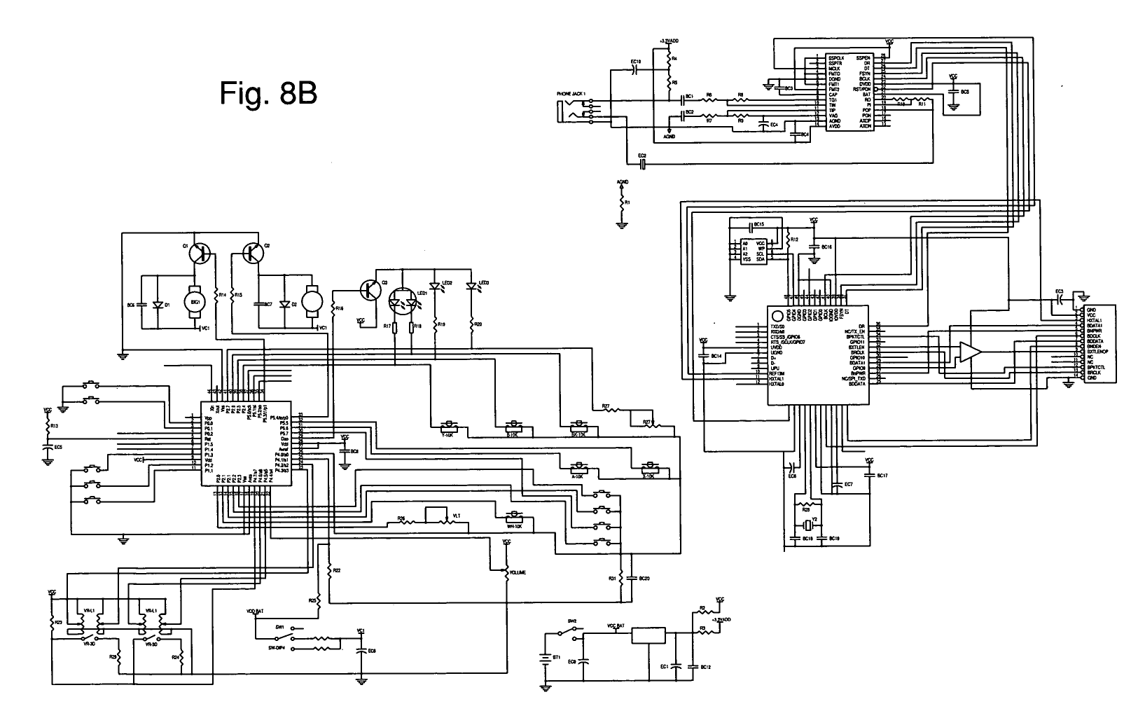

FIGS. 7a-7B depicts a block diagram and schematic of the adapter interface 68 to facilitate the wireless and live audio communication between the controller and gaming platform. This part is mainly controlled by Control Center. Key&VR is used to detect the keys&axes on the controller. An LED is used to indicate a variety of working statuses. The vibration message from the host is reacted by Motor Vibration. The RF signal is transmitted & received by RF Module. Data and Voice RF Controller is used to control the RF signal of the data (keys&motors) & invoice. Voice Codec is used to encode & decode the Voice. Power Modulation is used to regulate the power which is provided from battery, then output to all the circuit. A headset is for earphone & microphone. Battery is used for power supply.

The working theory as below: the Control Center detects key & axes message then transmit to Data and voice RF Controller, meanwhile Voice Codec will encode the Voice signal from Headset then transmit to Data and voice RF Controller, then Data and Voice RF Controller transmit to RF Module, finally transmit out by RF Module, meanwhile RF Module will pass the message of the motor vibration&Voice from Receiver to Data and voice RF Controller, Data and Voice RF controller will encode Voice message then pass to Headset, you can hear other partner's voice, at the same time Data and Voice RF Controller will encode the motor vibration message&transmit to Control Center, Control Center turn on the Motor Vibration circuit&vibrate the motors. At the same time, MCU will control LED display which will indicate all kinds of working status.

FIGS. 8a-8B This part is also mainly controlled by Control Center, LED is used to indicate the RF connection status, the RF signal is transmitted&received by RF Module, RF Control is used to control RF Module receiving &transmitting, and also combine&separate the signal then receive&transmit to other parts, USB Interface is used to transmit the message of keys&voice to XBOX Host and receive the message from motors&voice, then send it out, the whole power is provided by XBOX Host.

The working theory as below: RF Module get the message of keys&voice from Remote, then transmit to RF Control, RF Control transmit the keys message to Control Center, after decoding Control Center encode the keys message then pass to USB Interface, at the same time RF Control will directly transmit the voice signal to USB Interface, USB Interface will encode the signal of keys&motors and transmit to XBOX Host in different times, finally the motor message from XBOX Host will transmit out by RF Module according to opposite transmitted path of keys, the voice message form XBOX Host will transmit out by RF Module according to opposite transmitted path of voice, Control Center will check if it is illuminated or flashed according to the wireless connection.

The functional blocks diagram and specific structural schematic illustrate a preferred structure to support a wireless interface between the gaming platform and controller while also supporting wireless two way transmission of audio content to support communication between a player and the gaming console or between two gamers. This is particularly desirable during X-box live play between two players over a broadband network who are competing or playing together from remote locates. Such allows a user to not only control the game but also communicate through the game console through a wireless interface.

The wireless controllers, with integrated two-way audio communication includes a batter pack to supply power to the wireless controller during play. The wireless controller may make use of reaching schemes to allow the wireless controller to be recharged through direct connection to the gaming console and to facilitate alternate hard wired connection to allow play when the batteries are depicted. The wireless controller of the present invention may include the recharging circuitry and arrangements as shown and described in U.S. application Ser. No. 11/071,591 filed Mar. 4, 2005 which is hereby incorporated herein by reference. A light indicator may also be integrated into the controller to provide the status of charge of the battery. The voltage of the battery is simply detected and when low, a light can be caused to blink as a warning system to indicate low power. Bi-colored LED may also be employed where a green light is emitted when sufficient power exists (batter having a voltage over a predermined amount) and the LED turns red when the voltage drops below acceptable elves. A bar indicator may also be provided, as that shown in FIG. 4A to provide a graduated scale of the available power status of the battery.

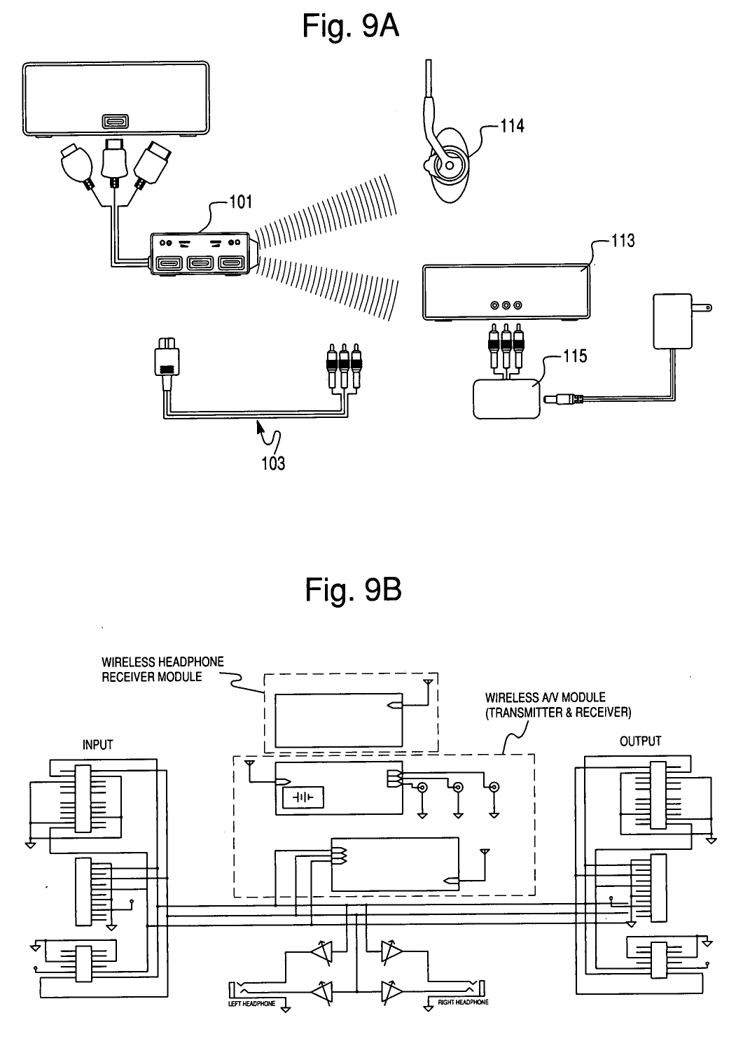

FIG. 9a illustrates an alternate embodiment of the present invention. In the present embodiment a universal wireless audio device enables the ability to convert a plurality of distinct gaming devices, or other electronic devices to wireless transmits audio and video signals to remote device. A center unit includes a plurality of communication cables to communicate with the AV output of a gaming device and includes at least three cables with specific pin out configurations to connect to a PS2, Game Cube and x box. An additional connection port exits for connecting conventional AV cables 103 to facilitate connection to a conventional audio vide device such as a television etc. The center until received the AV signals and wireless transmits. Audio is transmitted over an fm frequency for reception in an RF receiving headset 111. An audio video receiver device 115 receives the transmitted audio video signals and converts them to conventional signals for transmission over conventional cables for display on a vide device 113. The present embodiment facilitate the wireless transmission of audio vide signals to support remote location of a game screen, headset or other AV device remote from the game console. FIG. 9b depicts a schematic illustration of the wireless audio video module according to the present invention.

While the foregoing invention has been shown and described with reference to a preferred embodiment, it will be understood by those possessing skill in the art that various changes and modifications may be made without departing from the spirit and scope of the invention. For example, although this invention primarily relates to a wireless controller, it is also possible to use a communication cable to facilitate communication with a stand-alone computer gaming device. The communication cable may be employed when the batteries for the wireless aspect of the controller are being recharged and the communication cable may be used to transmit both control signals and power to and from the controller.

1. A video game controller for interaction with a stand-alone computer gaming system, said controller comprising:
a hand held body having a plurality of operation members logistically positioned for manipulation by a user,
transmitter/receiver circuitry integrated into said hand held body for sending and receiving wireless control signals to and from a game console;
audio circuitry capable of sending an audio signal to at least one speaker.

2. The controller recited in claim 1, further comprising an audio port adapted to communicate with a headset that connects with said controller via said audio port, said headset comprising said at least one speaker.

3. The controller recited in claim 1, wherein said audio signal comprises a primary audio signal transmitted by said game controller to a primary audio system.

4. The controller recited in claim 3, wherein said audio signal comprises a secondary audio signal different than said primary audio signal transmitted by said game controller to said main audio system.

5. The controller recited in claim 1, further comprising a microphone incorporated into said headset.

6. The controller recited in claim 5, wherein said microphone transmits player communication between players.

7. The controller recited in claim 6, wherein said microphone transmits said player communication between players through said game console.

8. The controller recited in claim 6, wherein said microphone transmits said player communication between players without sending any audio signal through said game console.

9. The controller recited in claim 6, wherein said microphone transmits said player communication directly to other players sending any audio signal through said game console.

10. A wireless video game controller adapted to operated and interact with a stand-alone computer gaming system with wired controllers connected thereto, said controller comprising:
a hand held body having a plurality of operation members logistically positioned for manipulation by a user, transmitter/receiver circuitry integrated into said hand held body for sending and receiving wireless control signals to and from a game console; audio circuitry capable of sending an audio signal to at least one speaker; and
a wireless conversion interface device provided to convert said stand-alone computer gaming system with wired controllers to wirelessly transmit said control and audio signals to said hand held body.

11. The controller recited in claim 10, wherein said wireless conversion interface includes a plurality of differently configures ports configured for hard wire connection to a selected one of a plurality of different type of gaming platforms.

12. The controller recited in claim 1, further comprising an audio port adapted to communicate with a headset that connects with said controller via said audio port, said headset comprising said at least one speaker.

13. The controller recited in claim 1, wherein said audio signal comprises a primary audio signal transmitted by said game controller to a primary audio system.

14. The controller recited in claim 3, wherein said audio signal comprises a secondary audio signal different than said primary audio signal transmitted by said game controller to said main audio system.

15. The controller recited in claim 1, further comprising a microphone incorporated into said headset.

16. The controller recited in claim 5, wherein said microphone transmits player communication between players.

17. The controller recited in claim 6, wherein said microphone transmits said player communication between players through said game console.

18. The controller recited in claim 6, wherein said microphone transmits said player communication between players without sending any audio signal through said game console.

19. The controller recited in claim 6, wherein said microphone transmits said player communication directly to other players sending any audio signal through said game console.
